(19) United States
(12) Patent Application Publication
(10) Pub. No.: US 2020/0350654 A1
(43) Pub. Date: Nov. 5, 2020

(54) Antenna Mounting System

(71) Applicant: Winegard Company, Burlington, IA (US)

(72) Inventors: Jared David Schmidgall, Mediapolis, IA (US); Timothy John Conrad, Mount Pleasant, IA (US)

(73) Assignee: Winegard Company, Burlington, IA (US)

(21) Appl. No.: 16/850,529

(22) Filed: Apr. 16, 2020

Related U.S. Application Data
(60) Provisional application No. 62/840,918, filed on Apr. 30, 2019.

(51) Int. Cl. H01Q 1/12; H01Q 3/08; H01Q 1/42

(52) U.S. Cl. CPC H01Q 1/125; H01Q 1/42; H01Q 3/08

(57) ABSTRACT

An antenna mounting system has a base assembly secured to a pipe mount, and a rotating assembly that supports the antenna and allows azimuth rotation. The base assembly includes a tubular insert extending downward into the pipe and a conical bearing surface. The rotating assembly has a tapered insert that slides into the tubular insert of the base assembly, and a conical bearing surface that is complementary to the conical bearing surface of the base assembly. The bottom of the tapered insert of the rotating assembly is rotatably secured to the bottom of the tubular insert of the base assembly by means of a fastener that permits azimuth rotation of the rotating assembly and antenna with respect to the base assembly. However, this configuration prevents axial (i.e., vertical) movement and movement in the horizontal plane.

### RELATED APPLICATION

The present application is based on and claims priority to the Applicant's U.S. Provisional Patent Application 62/840,918, entitled “Antenna Mounting System,” filed on Apr. 30, 2019.

### BACKGROUND OF THE INVENTION

### Field of the Invention

The present invention relates generally to the field of antenna mounting systems. More specifically, the present invention discloses a system for mounting an antenna to a pipe mount that allows azimuth rotation of the antenna on conical bearing surfaces housed within the pipe.

### Statement of the Problem

Pipes and other types of mounting masts have long been used to support antennas. The pipe mount typically extends vertically upward from a building structure, vehicle or tower to increase the elevation and field of view of the antenna. For example, the antenna can simply be secured to the exterior of the pipe with U-shaped bolts or straps.

Directional antennas usually require a mechanism for adjusting their position. Many antennas for over-the-air television and radio communications include a mechanism to rotate the antenna in the azimuth plane (i.e., about a vertical axis). Satellite antennas typically include mechanisms for both azimuth and elevation adjustments. One conventional approach has been to provide a fixed connection between the pipe mount and the positioning mechanism, which then supports and positions the antenna. This configuration typically leaves the support and positioning mechanisms outside of the pipe.

The prior art in this field also includes antenna mounting systems that place various types of bearing surfaces within the pipe to allow azimuth rotation of the antenna. However, these antenna mounting systems tend to be difficult to assemble while maintaining close tolerances. Optimal antenna performance requires high degrees of stability and accuracy in positioning the antenna, particularly for residential satellite antennas or mobile satellite antennas. In addition, such antenna mounting systems tend to be subject to binding or locking of the bearing components due to misalignment or wear.

### Solution to the Problem

The present invention addresses these shortcoming in the prior art by providing an antenna mounting system that employs a conical bearing interface extending inside the pipe mount to maintain structural rigidity and low deflection while allowing smooth azimuth rotation that can be driven by mechanical means. In addition, this configuration and the surrounding pipe mount provide a degree of protection for the bearing surfaces from the elements.

### SUMMARY OF THE INVENTION

This invention provides an antenna mounting system having a base assembly secured to a pipe mount, and a rotating assembly that supports the antenna and allows azimuth rotation with respect to the base assembly. The base assembly has a tubular insert that extends downward into the pipe and a conical bearing surface. The rotating assembly has a tapered insert that slides into the tubular insert of the base assembly, and a conical bearing surface that is complementary to the conical bearing surface of the base assembly. The bottom of the tapered insert of the rotating assembly is rotatably secured to the bottom of the tubular insert of the base assembly by means of a fastener that permits azimuth rotation of the rotating assembly and antenna with respect to the base assembly. However, this configuration prevents axial (e.g., vertical) movement and movement in the horizontal plane.

These and other advantages, features, and objects of the present invention will be more readily understood in view of the following detailed description and the drawings.

### BRIEF DESCRIPTION OF THE DRAWINGS

The present invention can be more readily understood in conjunction with the accompanying drawings, in which:

FIG. 1 is an exploded top axonometric view of the rotating assembly 1, base assembly 2 and a pipe mount 3.

FIG. 2 is a bottom axonometric view of the rotating assembly 1.

FIG. 3 is a detail front view of the rotating assembly 1 and base assembly 2 on the pipe mount 3.

FIG. 4 is a vertical cross-sectional view of the rotating assembly 1, base assembly 2 and pipe mount 3.

FIG. 5 is a top axonometric view of an antenna 4 mounted on the rotating assembly 1, base assembly 2 and pipe mount 3.

### DETAILED DESCRIPTION OF THE INVENTION

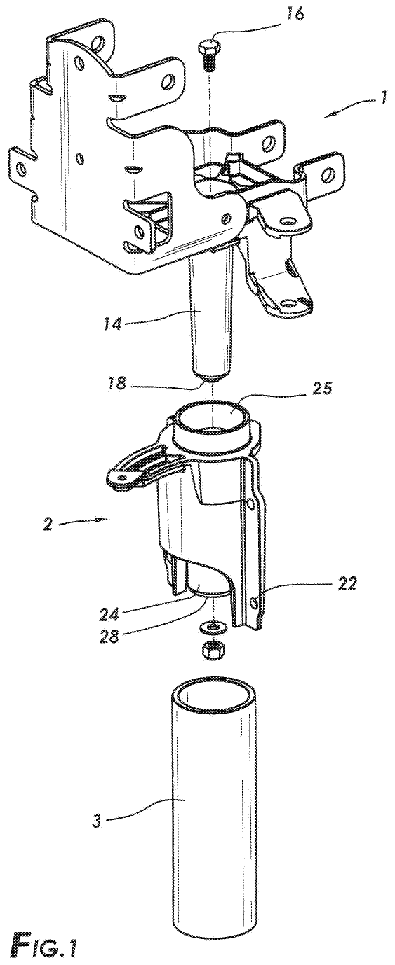

Turning to FIG. 1, an exploded view is provided showing the major components of the present invention. A base assembly 2 is secured to the upper end of the mounting mast or pipe mount 3. This base assembly 2 can be temporarily or permanently attached to the pipe 3 by means of a fastener 22, such as a clamp, screws, bolts or clip. For example, the pipe mount 3 can be a conventional tubular member, or a cylindrical or rectangular pipe.

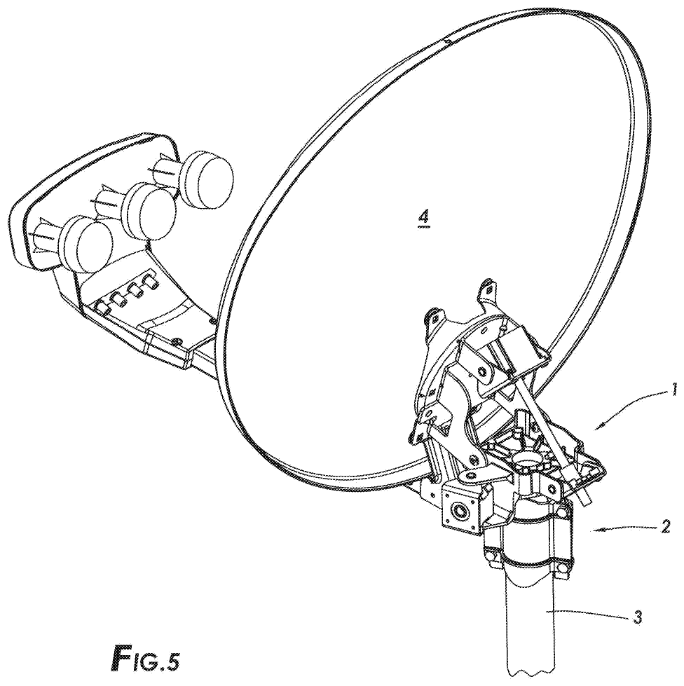

A tubular insert 24 extends downward from the lower portion of the base assembly 2, as shown in FIGS. 1 and 4. This tubular insert 24 has outside dimensions that allow it to be inserted into the upper end of the pipe 3 as shown in FIG. 4. It also has a cylindrical inner surface that may be tapered toward the bottom 28 of the tubular insert 24. A conical bearing surface 25 extends radially outward about the upper end of the cylindrical inner surface of the insert 24. More specifically, the conical bearing surface extends radially about an axis of symmetry parallel to the axis of the pipe mount (typically a vertical axis), and is tapered inward toward its lower end, as shown in FIG. 1. This conical bearing surface 25 also shares a common axis of symmetry with the remainder of the insert 24 to allow azimuth rotation of the rotating assembly 1 and antenna 4 with respect to the base assembly 2 and pipe mount 3, as will be described below.

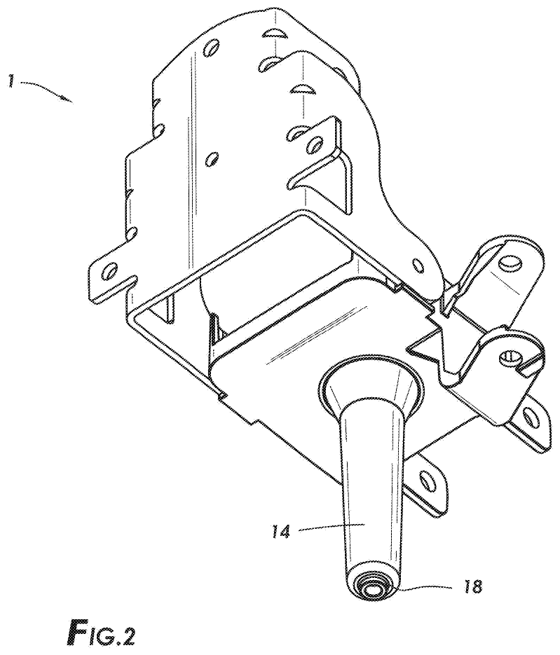

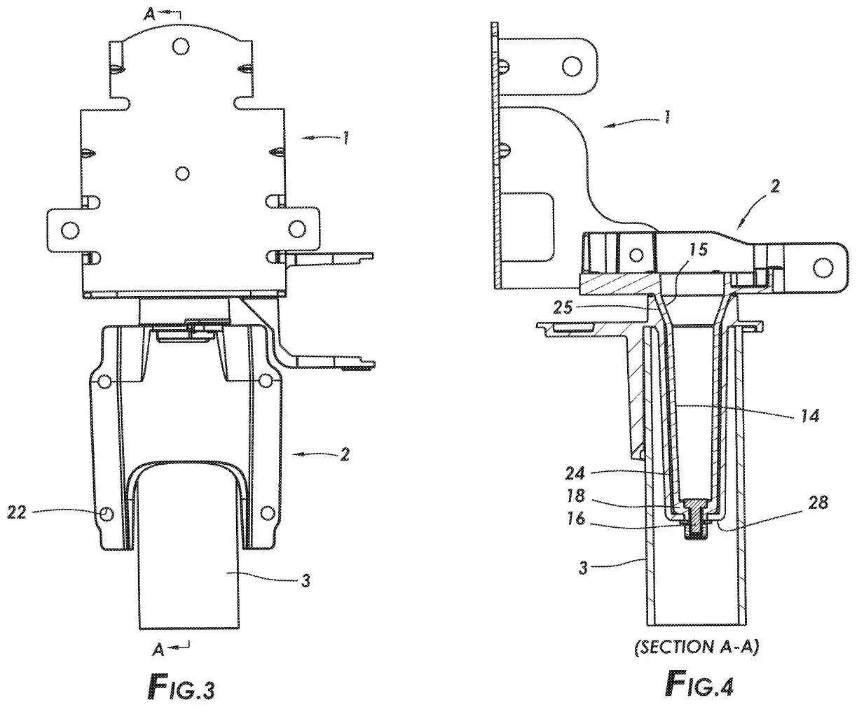

A rotating assembly 1 is mounted atop the base assembly 2 as illustrated in FIGS. 3 and 5. The base assembly 2 provides rigid structural support on the pipe mount 3, while the rotating assembly 1 allows azimuth rotation of the antenna 4 about the vertical axis. The rotating assembly 1 has a tapered insert 14 that slides into the tubular insert 24 of the base 2, as shown in FIG. 4. The outer surface of the tapered insert 14 is complementary to the inner surface of the tubular insert 24 of the base 2 to allow free rotation of the rotating assembly 1 with respect to the base assembly 2 and pipe mount 3. Similarly, a conical bearing surface 15 extends radially outward about the upper end of the tapered insert 14 as shown in FIG. 2. More specifically, this conical bearing surface 15 extends radially about the common axis of symmetry (e.g., a vertical axis), and is tapered inward toward its lower end. The conical bearing surfaces 15 and 25 on the rotating assembly 1 and base assembly 2, respectively, are complementary to support the rotating assembly 1 on the base assembly 2 and also allow azimuth rotation.

A fastener 16 secures the bottom 18 of the rotating assembly 1 to the bottom 28 of the base assembly 2. For example, this fastener 16 could be a nut and bolt, pin or rivet. In the embodiment shown in FIGS. 1 and 4, the fastener 16 extends through the bottoms 18, 28 of the base assembly 2 and rotating assembly 1. This prevents any significant axial (i.e., vertical) movement or movement in the horizontal plane, but allows azimuth rotation.

The present invention allows for automatic or manual rotation in the azimuth plane while minimizing deflection and also eliminating the need for extra parts, such as a bushing or bearing. The conical shape of the bearing surfaces 15, 25 prevents locking or binding, and allows smooth rotation in the azimuth plane between the base assembly 2 and rotating assembly 1. Current methods for installing such a rotating assembly to a fixed base are usually manually adjusted and then tightened to minimize deflection. The present invention also allows for smooth but secure rotation, and can be rotated by a motor or other mechanical means.

The above disclosure sets forth a number of embodiments of the present invention described in detail with respect to the accompanying drawings. Those skilled in this art will appreciate that various changes, modifications, other structural arrangements, and other embodiments could be practiced under the teachings of the present invention without departing from the scope of this invention as set forth in the following claims.

We claim:

1. An antenna mounting system for rotatably mounting an antenna to a pipe mount, said system comprising:
a base assembly secured to the pipe mount and having:
(a) a tubular insert extending into the pipe mount, having an upper end and a bottom; and
(b) a conical bearing surface;
a rotating assembly supporting the antenna and having:
(a) a tapered insert for sliding insertion into the tubular insert of the base assembly within the pipe mount, having an upper end and a bottom, and
(b) a conical bearing surface complementary to the conical bearing surface of the base assembly enabling rotation of the rotating assembly and antenna with respect to the base assembly and pipe mount; and
a fastener rotatably securing the bottom of the tapered insert of the rotating assembly to the bottom of the tubular insert of the base assembly to prevent axial movement between the rotating assembly and base assembly.

2. The antenna mounting system of claim 1 wherein the conical bearing surface of the rotating assembly extends radially outward about the upper end of the tapered insert.

3. The antenna mounting system of claim 1 wherein the tapered insert of the base assembly is substantially tubular.

4. The antenna mounting system of claim 1 wherein the tapered insert of the base assembly has a substantially cylindrical inner surface tapering inward toward the bottom of the tapered insert.

5. The antenna mounting system of claim 4 wherein the conical bearing surface of the base assembly extends radially outward from the upper end of the tapered insert of the base assembly.

6. The antenna mounting system of claim 1 wherein the fastener comprises a nut and bolt.

7. The antenna mounting system of claim 1 wherein the fastener comprises a rivet.

8. The antenna mounting system of claim 1 wherein the fastener comprises a pin.

9. The antenna mounting system of claim 1 wherein the pipe mount is substantially vertical and the rotating assembly and antenna rotate in the azimuth plane.

10. The antenna mounting system of claim 1 wherein the conical bearing surface of the base assembly is within the pipe mount.

11. An antenna mounting system for rotatably mounting an antenna to a pipe mount, said system comprising:
a base assembly secured to the pipe mount and having:
(a) a tubular insert extending into the pipe mount, having an upper end and a bottom; and
(b) a conical bearing surface extending radially outward from the upper end of the tubular insert;
a rotating assembly supporting the antenna and having:
(a) a tapered insert for sliding insertion into the tubular insert of the base assembly within the pipe mount, having an upper end and a bottom, and
(b) a conical bearing surface extending radially outward from the upper end of the tapered insert and being complementary to the conical bearing surface of the base assembly, said conical bearing surfaces supporting the rotating assembly on the base assembly and enabling rotation of the rotating assembly and antenna with respect to the base assembly and pipe mount; and
a fastener rotatably securing the bottom of the tapered insert of the rotating assembly to the bottom of the tubular insert of the base assembly to prevent axial movement between the rotating assembly and base assembly.

12. The antenna mounting system of claim 11 wherein the tapered insert of the base assembly is substantially tubular.

13. The antenna mounting system of claim 11 wherein the tapered insert of the base assembly has a substantially cylindrical inner surface tapering inward toward the bottom of the tapered insert.

14. The antenna mounting system of claim 11 wherein the conical bearing surface of the base assembly is within the pipe mount.
